(19) United States
(12) Patent Application Publication
(10) Pub. No.: US 2003/0036370 A1
(43) Pub. Date: Feb. 20, 2003

(54) Method of using bipolar junction transistor as local oscillator in a satellite down converter to eliminate second and third harmonic interference between two local oscillators

(75) Inventor: Mao-Jen Chen, Chung-Li City (TW)

Correspondence Address: DOUGHERTY & TROXELL, Suite 1404, 5205 Leesburg Pike, Falls Church, VA, 22041, US

(73) Assignee: Prime Electronics & Statellitcs Inc.

(21) Appl. No.: 09/928,417

(22) Filed: Aug. 14, 2001

(51) Int. Cl. H04B 1/06

(52) U.S. Cl. 455/256; 455/296

(57) ABSTRACT

A method of using a bipolar junction transistor as a local oscillator in a satellite down converter to eliminate second and third harmonic interference between two local oscillators mainly includes serial connection of a mixer between a low-noise amplifier and an intermediate frequency amplifier in the satellite down converter, and serial connection of a bipolar junction transistor (BJT) to the mixer, so that the satellite down converter may have reduced phase noise and reduced power consumption, and that second and third harmonic interference at the same frequency range is eliminated.

### FIELD OF THE INVENTION

The present invention relates to a method of using bipolar junction transistor as local oscillator in a satellite down converter to eliminate second and third harmonic interference between two local oscillators, and more particularly to a method of using bipolar junction transistor as local oscillator in a satellite down converter to eliminate second and third harmonic interference between two local oscillators by replacing a conventional field effect transistor with a bipolar junction transistor.

### BACKGROUND OF THE INVENTION

Generally, a field effect transistor (MESFET) is used as a local oscillator. In this case, the local oscillator may have a large output. However, following disadvantages are found when the field effect transistor is used as a local oscillator:

1. High power consumption is required.

2. High second and third harmonic interference exists.

FIG. 1 is a basic circuit diagram for a conventional satellite down converter that usually uses a field effect transistor as a local oscillator. As shown, the satellite down converter includes receivers 10, 10′ having a receiving frequency within a range from 11.7 to 12.2 GHz, behind which low-noise amplifiers 11, 11′, are respectively provided. A mixer 12 is serially connected between the low-noise amplifier 11 and an intermediate frequency (IF) amplifier 13, and a field effect transistor (MESFET) 14 is serially connected to the mixer 12. Similarly, a mixer 12′ is serially connected between the low-noise amplifier 11′ and an intermediate frequency (IF) amplifier 13′, and a field effect transistor (MESFET) 14′ is serially connected to the mixer 12′. And, an output port 15 is connected to outputs of the IF amplifiers 13, 13′.

Wherein, a frequency at the output of the IF amplifier 13 is within the range from 1550 to 2050 MHz, and a frequency at the output of the IF amplifier 13′ is within the range from 950 to 1450 MHz. These two frequencies combine at the output port 15 to be within the range from 950 to 2050 MHz. In the above-described circuit structure, the output thereof would generate second and third harmonic interference at the same frequency range to adversely affect the signal receiving ability of the satellite down converter. It is desirable to improve the above-mentioned problem with the circuit of the conventional satellite down converter.

In view of the above-mentioned drawbacks existing in the use of the field effect transistor as a local oscillator, as well as the problem of second and third harmonic interferences existing in the conventional satellite down converter, it is tried by the inventor to develop a method to eliminate these problems.

### SUMMARY OF THE INVENTION

A primary object of the present invention is to provide a method of using a bipolar junction transistor as a local oscillator in a satellite down converter to eliminate second and third harmonic interference between two local oscillators.

To achieve the above and other objects, the method of the present invention is to serially connect a mixer between a low-noise amplifier and an intermediate frequency (IF) amplifier of a satellite down converter, and to serially connect a bipolar junction transistor to the mixer for serving as a local oscillator of the satellite down converter.

The use of the bipolar junction transistor as a local oscillator enables reduced phase noise and lowered power consumption. Moreover, the bipolar junction transistor is operative to eliminate second and third harmonic interference at the same frequency range.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a basic circuit diagram for a satellite down converter, which, when in a conventional form, uses field effect transistors as the local oscillators, and, when in a form according to a preferred embodiment of the present invention, uses bipolar junction transistors as the local oscillators.

### DETAILED DESCRIPTION OF THE PREFERRED EMBODIMENTS

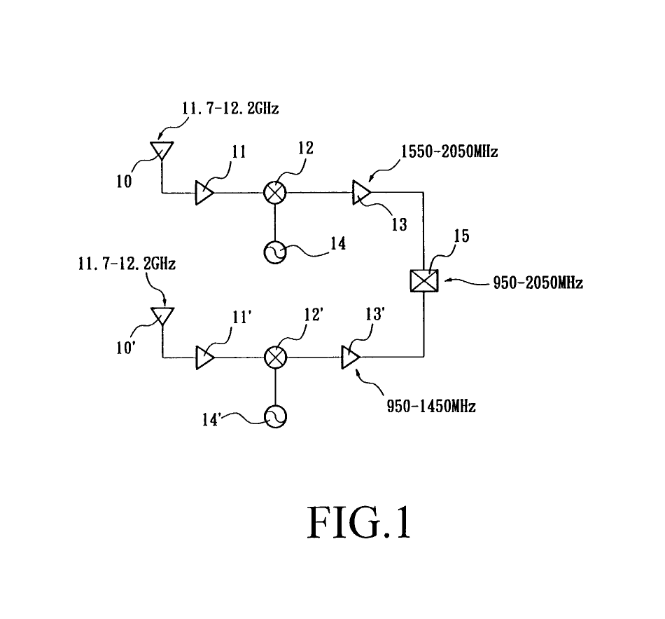

Please refer to FIG. 1 that is a basic circuit diagram for a satellite down converter. The present invention is intended to provide a method of using a bipolar junction transistor as a local oscillator in the satellite down converter to eliminate second and third harmonic interference between two local oscillators.

According to the method of the present invention, the satellite frequency reduce of FIG. 1 is provided with two receivers 10, 10′ that have a receiving frequency within a range from 11.7 to 12.2 GHz, behind which two low-noise amplifiers 11, 11′ are respectively provided. A mixer 12 is serially connected between the low-noise amplifier 11 and an intermediate frequency (IF) amplifier 13, and a bipolar junction transistor (BJT) 14 is serially connected to the mixer 12. Similarly, a mixer 12′ is serially connected between the low-noise amplifier 11′ and an intermediate frequency (IF) amplifier 13′, and a bipolar junction transistor (BJT) 14′ is serially connected to the mixer 12′. And, an output port 15 is connected to outputs of the IF amplifiers 13, 13′.

The satellite down converter structured according to the method of the present invention has the following advantages:

1. The power consumption is reduced. The satellite down converter structured according to the present invention consumes power about only 60% of that of a conventional satellite down converter using the field effect transistor (MESFET) as the local oscillator.

2. The phase noise is reduced.

3. The second and the third harmonics are about 20 to 30 dB lower than that found in the case of using a MESFET as the local oscillator.

In conclusion, a satellite down converter structured in the method of the present invention to include a bipolar junction transistor as the local oscillator has reduced power consumption and reduced second and third harmonic interference, and therefore enables clear reception and transmission of signals through a satellite. The present invention is therefore industrially practical and valuable.

The present invention has been described with a preferred embodiment thereof and it is understood that many changes and modifications in the described embodiment can be carried out without departing from the scope and the spirit of the invention. And, it is to be noted that the use of a bipolar junction transistor to replace the field effect transistor necessitates changes of associated electronic circuit and arrangement of pins. However, since such changes may be made by a person having ordinary skill of the art based on the disclosure of the present invention, they are not discussed in details herein. It is apparent the present invention is intended to be limited only by the appended claims.

What is claimed is:

1. A method of using a bipolar junction transistor as a local oscillator in a satellite down converter to eliminate second and third harmonic interference between two local oscillators, comprising serial connection of a mixer between a low-noise amplifier and an intermediate frequency amplifier in said satellite down converter, and serial connection of a bipolar junction transistor (BJT) to said mixer, whereby said satellite down converter may have reduced phase noise and reduced power consumption, and second and third harmonic interference at the same frequency range is eliminated.
